(19) United States
(12) Patent Application Publication
(10) Pub. No.: US 2019/0174954 A1
(43) Pub. Date: Jun. 13, 2019

(54) Disposable Grill Assembly

(71) Applicant: Pierre McBride, Milwaukee, WI (US)

(72) Inventor: Pierre McBride, Milwaukee, WI (US)

(21) Appl. No.: 15/840,032

(22) Filed: Dec. 13, 2017

(51) Int. Cl. A47J 37/07

(52) U.S. Cl. CPC A47J 37/0763; A47J 2037/0795; A47J 37/0786

(57) ABSTRACT

A disposable grill assembly includes a base that is selectively positioned on a support surface. A stand is coupled to and extends upwardly from the base. A pan is provided and the pan is selectively positioned on the stand having the pan being spaced from the support surface. The pan contains a flammable fuel source and the pan is comprised of a heat resistant material to have the flammable fuel source burnt therein for cooking. A grill is selectively positioned on the pan such that the grill is in thermal communication with the flammable fuel source. The food item is positioned on the grill for cooking.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to grill devices and more particularly pertains to a new disposable grill device for cooking outdoors.

### BRIEF SUMMARY OF THE INVENTION

An embodiment of the disclosure meets the needs presented above by generally comprising a base that is selectively positioned on a support surface. A stand is coupled to and extends upwardly from the base. A pan is provided and the pan is selectively positioned on the stand having the pan being spaced from the support surface. The pan contains a flammable fuel source and the pan is comprised of a heat resistant material to have the flammable fuel source burnt therein for cooking. A grill is selectively positioned on the pan such that the grill is in thermal communication with the flammable fuel source. The food item is positioned on the grill for cooking.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a disposable grill assembly according to an embodiment of the disclosure.

FIG. 2 is an exploded perspective view of an embodiment of the disclosure.

FIG. 3 is an exploded view of grill and a sleeve of an embodiment of the disclosure.

FIG. 4 is a cross sectional view taken along line 4-4 of FIG. 1 of an embodiment of the disclosure.

FIG. 5 is a top view of an embodiment of the disclosure.

### DETAILED DESCRIPTION OF THE INVENTION

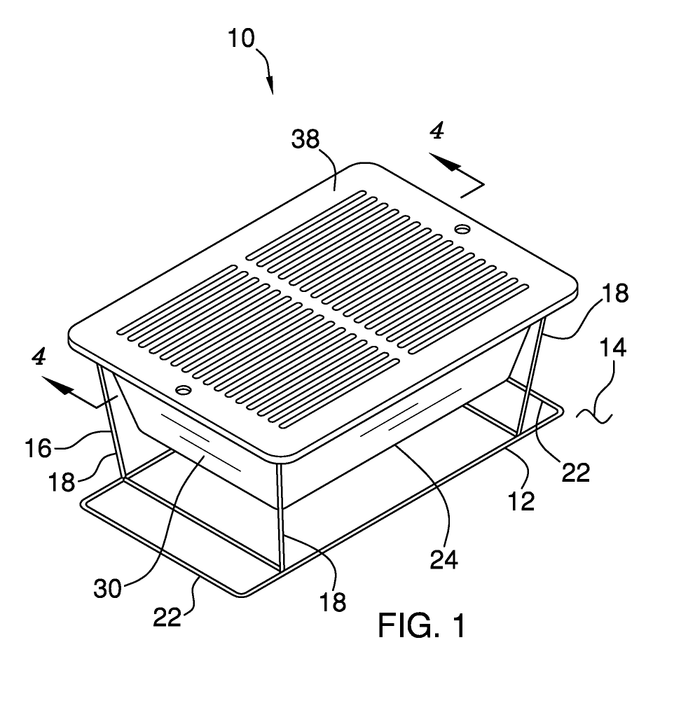

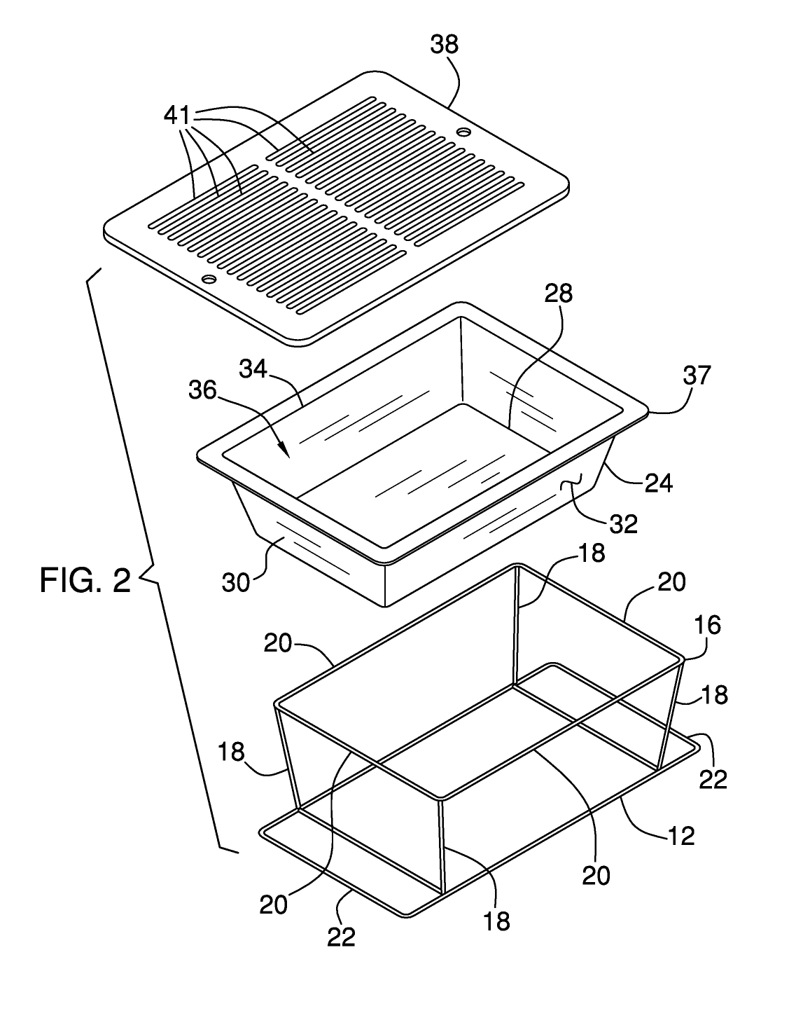

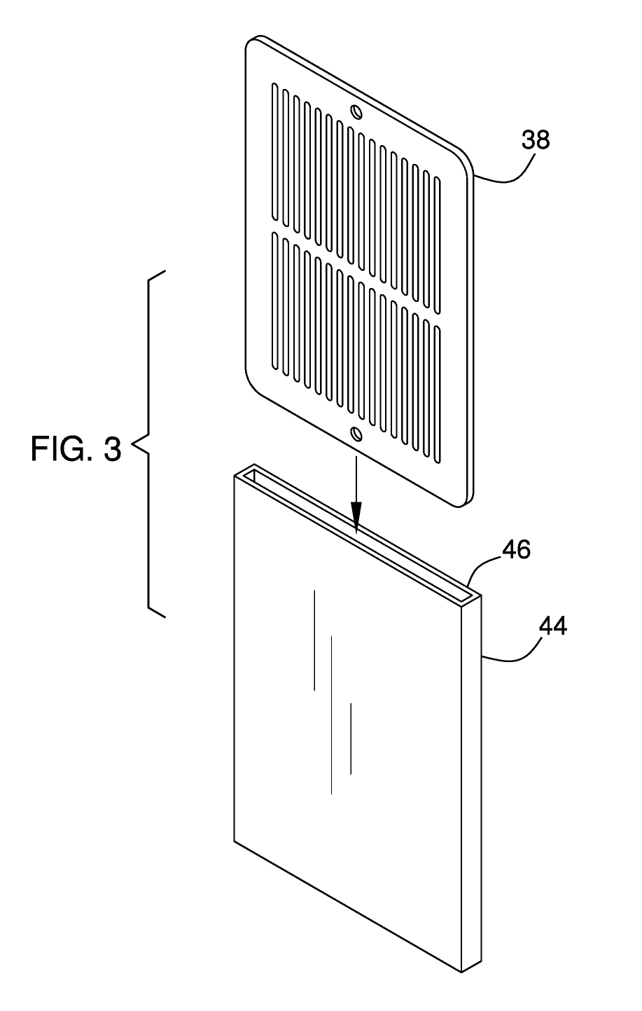

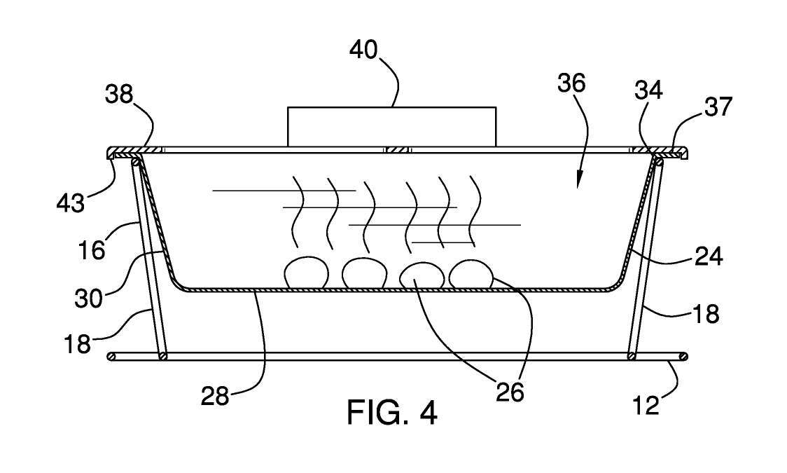

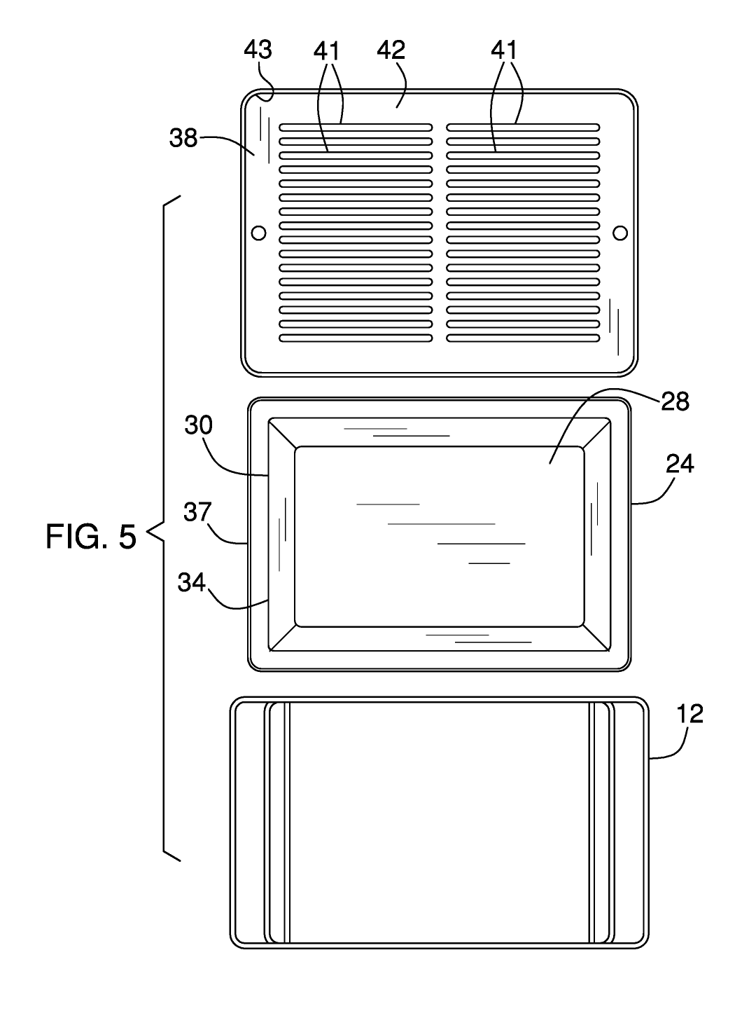

With reference now to the drawings, and in particular to FIGS. 1 through 5 thereof, a new grill device embodying the principles and concepts of an embodiment of the disclosure and generally designated by the reference numeral 10 will be described.

As best illustrated in FIGS. 1 through 5, the disposable grill assembly 10 generally comprises a base 12 that is selectively positioned on a support surface 14 such as ground and any other non-flammable support surface 14. A stand 16 is provided and the stand 16 is coupled to and extends upwardly from the base 12. The stand 16 includes a plurality of vertical members 18 extending upwardly from the base 12 and a plurality of horizontal members 20 extending between each of the vertical members 18. Each of the horizontal members 20 is spaced from the base 12 and the horizontal members 20 form a rectangle. The base 12 may include a pair of end members 22 and each of the vertical members 18 of the stand 16 may be spaced from an associated one of the end members 22.

A pan 24 is provided and the pan 24 is selectively positioned on the stand 16 such that the pan 24 is spaced from the support surface 14. A flammable fuel source 26, such as charcoal briquettes or the like, is selectively positioned in the pan 24. The pan 24 is comprised of a heat resistant thereby facilitating the flammable fuel source 26 to be burnt in the pan 24 for cooking.

The pan 24 has a bottom wall 28 and a peripheral wall 30 extending upwardly therefrom. The peripheral wall 30 has an outer surface 32 and a top edge 34 and the top edge 34 defines an opening 36 into the pan 24. The flammable fuel source 26 is positioned on the bottom wall 28 for burning. The pan 24 may be comprised of a recyclable material, such as aluminum foil or the like. Thus, the pan 24 may be disposed of and recycled when the flammable fuel source 26 is finished burning. A support 37 extends outwardly from the outer surface 32 of the peripheral wall 30. The support 37 is coextensive with the peripheral wall 30 and the support 37 is aligned with the top edge 34.

A grill 38 is selectively positioned on the pan 24 such that the grill 38 is in thermal communication with the flammable fuel source 26. A food item 40, such as raw meat or the like, is positioned on the grill 38 for cooking. The grill 38 has a bottom side 42 and the bottom side 42 rests upon the support on the pan 24 when the grill 38 is positioned on the pan 24. Thus, the grill 38 is spaced from the bottom wall 28 of the pan 24. The grill 38 may have a plurality of vents 41 extending through the grill 38 thereby facilitating heat from the flammable fuel source 26 to pass through the grill 38.

A lip 43 extends downwardly from the bottom side 42 of the grill 38 and the lip 43 is coextensive with a perimeter of the grill 38. The lip 43 engages the support 37 on the pan 24 when the grill 38 is positioned on the pan 24 thereby inhibiting the grill 38 from sliding off of the pan 24. A sleeve 44 is provided and the sleeve 44 has a first end 46. The first end 46 is open into an interior of the sleeve 44 and the first end 46 insertably receives the grill 38 for storage. The sleeve 44 may be comprised of a heat resistant material.

In use, the base 12 is positioned on the support surface 14 and the pan 24 is positioned on the stand 16 having the support resting on the horizontal members 20. The flammable fuel source 26 is positioned in the pan 24 for burning. The grill 38 is positioned on the pan 24 and the food item 40 is positioned on the grill 38. In this way the food item 40 is cooked when the flammable fuel source 26 is burned. The pan 24 is discarded when the food item 40 is finished cooking and the flammable fuel source 26 has finished burning.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A disposable grill assembly being configured to contain a flammable fuel source for cooking, said assembly comprising:
a base being configured to be positioned on a support surface;
a stand being coupled to and extending upwardly from said base;
a pan being selectively positioned on said stand wherein said pan is configured to be spaced from the support surface, said pan being configured to contain a flammable fuel source, said pan being comprised of a heat resistant material wherein said pan is configured to have the flammable fuel source burnt therein for cooking; and
a grill being selectively positioned on said pan wherein said grill is configured to be in thermal communication with the flammable fuel source, said grill being configured to have a food item positioned thereon for cooking.

2. The assembly according to claim 1, wherein said stand includes a plurality of vertical members extending upwardly from said base and a plurality of horizontal members extending between each of said vertical members, each of said horizontal members being spaced from said base, each of said horizontal members forming a rectangle.

3. The assembly according to claim 1, wherein said pan has a bottom wall and a peripheral wall extending upwardly therefrom, said peripheral wall having an outer surface and a top edge, said top edge defining an opening into said pan, said bottom wall being configured to have the flammable fuel source positioned thereon.

4. The assembly according to claim 3, further comprising a support extending outwardly from said outer surface of said peripheral wall, said support being coextensive with said peripheral wall, said support being aligned with said top edge:

5. The assembly according to claim 4, wherein:
said stand includes a plurality of horizontal members; and
said support resting upon said horizontal members when said pan is positioned on said stand.

6. The assembly according to claim 5, wherein said grill has a bottom side, said bottom side resting upon said support on said pan when said grill is positioned on said pan such that said grill is spaced from said bottom wall of said pan.

7. A disposable grill assembly being configured to contain a flammable fuel source for cooking, said assembly comprising:
a base being configured to be positioned on a support surface;
a stand being coupled to and extending upwardly from said base, said stand including a plurality of vertical members extending upwardly from said base and a plurality of horizontal members extending between each of said vertical members, each of said horizontal members being spaced from said base, each of said horizontal members forming a rectangle;
a pan being selectively positioned on said stand wherein said pan is configured to be spaced from the support surface, said pan being configured to contain a flammable fuel source, said pan being comprised of a heat resistant material wherein said pan is configured to have the flammable fuel source burnt therein for cooking, said pan having a bottom wall and a peripheral wall extending upwardly therefrom, said peripheral wall having an outer surface and a top edge, said top edge defining an opening into said pan, said bottom wall being configured to have the flammable fuel source positioned thereon;
a support extending outwardly from said outer surface of said peripheral wall, said support being coextensive with said peripheral wall, said support being aligned with said top edge; and
a grill being selectively positioned on said pan wherein said grill is configured to be in thermal communication with the flammable fuel source, said grill being configured to have a food item positioned thereon for cooking, said grill having a bottom side, said bottom side resting upon said support on said pan when said grill is positioned on said pan, such that said grill is spaced from said bottom wall of said pan.
